(19) United States
(12) Patent Application Publication
(10) Pub. No.: US 2013/0052438 A1
(43) Pub. Date: Feb. 28, 2013

(54) MAX-PHASE ORIENTED CERAMIC AND METHOD FOR PRODUCING THE SAME

(71) Applicants: Chunfeng Hu, Ibaraki (JP); Salvatore Grasso, Ibaraki (JP); Yoshio Sakka, Ibaraki (JP); Hidehiko Tanaka, Ibaraki (JP); Tohru Suzuki, Ibaraki (JP)

(72) Inventors: Chunfeng Hu, Ibaraki (JP); Salvatore Grasso, Ibaraki (JP); Yoshio Sakka, Ibaraki (JP); Hidehiko Tanaka, Ibaraki (JP); Tohru Suzuki, Ibaraki (JP)

(73) Assignee: NATIONAL INSTITUTE FOR MATERIALS SCIENCE, Ibaraki (JP)

(21) Appl. No.: 13/661,756

(22) Filed: Oct. 26, 2012

Related U.S. Application Data
(63) Continuation of application No. PCT/JP2011/059908, filed on Apr. 22, 2011.

(30) Foreign Application Priority Data
Apr. 30, 2010 (JP) 2010-104687

(51) Int. Cl. C04B 35/515; B29C 67/04

(52) U.S. Cl. 428/213; 264/430

(57) ABSTRACT

An oriented ceramic containing an Mₙ₊₁AXₙ phase, where the Mₙ₊₁AXₙ phase is a ternary compound, and M is an early transition metal, A is an A group element, X is C or N, and n is an integer of 1 to 3, wherein the oriented ceramic has a layered microstructure similar to shell layers of pearl, which is formed by laminating a layer of a nano-order to milli-order in a thickness thereof, and the oriented ceramic is an oriented bulk material a total thickness of which is in milli-order or larger at smallest.

### CROSS-REFERENCE TO RELATED APPLICATION

This application is a continuation of PCT/JP2011/059908, filed on Apr. 22, 2011, which claims priority of Japanese application No. 2010-104687, filed on Apr. 30, 2010, the entire contents of which are incorporated herein by reference.

### BACKGROUND OF THE INVENTION

1. Field of the Invention

The present invention relates to a MAX phase ceramic with sufficient orientation of the MAX phase, obtained by sufficiently orientating (texture of) the MAX phase, and to a method for producing the same.

2. Description of the Related Art

A Mₙ₊₁AXₙ(M is a transition meta; and A is an A group element (that is often belong to the IIIA group or IVA group, and contains Cd, Al, Ga, In, Ti, Si, Ge, Sn, Pb, P, As, and S, and n=1 to 3)) compound, which are ternary compounds, are also called MAX phases, and these compounds have crystallized multilayer microstructure of hexagonal crystals. In a crystal structure of each of M₂AX, M₃AX₂, M₄AX₃ phases, respectively, every third, fourth, and fifth layer are a layer of an A group element. A thin layered ceramic containing the MAX phase has combined characteristics of metal and ceramic, such as high strength, high Young's modulus, and excellent electric and thermal conductivity, together with simple machinability, excellent damage resistance, and thermal shock resistance (see U.S. Pat. Nos. 5,882,561, 5,942,455, 6,231,969, 6,461,989, and 7,235,505). To date, more than fifty M₂AX phases, five M₃AX₂ phases (Ti₃SiC₂, Ti₃AlC₂, Ti₃GeC₂, Ti₃SnC₂, and Ta₃AlC₂), and seven M₄AX₃ phases (Ta₄AlC₃, Ti₄AlN₃, Ti₄SiC₃, Ti₄GeC₃, Nb₄AlC₃, V₄AlC₃, and Ti₄GaC₃) have been found (see Barsoum et al., “The MN+1AXN Phases: a New Class of Solids; Thermodynamically Stable Nanolaminates”, Prog. Solid State Chem. 28: 201-281 (2000), and Hu et al., “In Situ Reaction Synthesis, Electrical and Thermal, and Mechanical Properties of Nb₄AlC₃”, J. Am. Ceram. Soc. 91: 2258-2263 (2008)). Further, several new MAX phases have been discovered by a solid solution method, such as (Ti,Nb)₂AlC, Ti₃Si(Al)C₂, Ti₃Si(Ge)C₂, (V,Cr)₃AlC₂, (V,Cr)₄AlC₃, and (V,Cr)₂GeC (see Hu et al., “In Situ Reaction Synthesis, Electrical and Thermal, and Mechanical Properties of Nb₄AlC₃”, J. Am. Ceram. Soc. 91: 2258-2263 (2008)). It has been discovered that there are two types of orders of lamination of atoms along the [0001] direction in the crystal structure of the M₄AX₃. One of the atom arrangements, ABABACBCBC, belong to atom arrangements of Ti₄AlN₃, Ti₄SiC₃, Ti₄GeC₃, α-Ta₄AlC₃, Nb₄AlC₃, and V₄AlC₃, and the other type of the atom arrangements, ABABABABAB, belong to only an atom arrangement of β-Ta₄AlC₃. It is assumed that the atom arrangement is varied because of variations in positions of atoms in a crystal structure.

It has been found that an oriented microstructure film, which is sufficiently dense, and a basal plane of which is parallel to a surface thereof, can be obtained by tape casting and/or cold pressing fine Ti₃SiC₂, followed by pressureless sintering in an argon atmosphere, or Si-rich atmosphere (see Barsoum et al., “The MN+1AXN Phases: a New Class of Solids; Thermodynamically Stable Nanolaminates”, Prog. Solid State Chem. 28: 201-281 (2000).). Further, it has been known that ceramic crystals having asymmetric unit cells exhibit crystal magnetic anisotropy. There are reports that control and design of an oriented texture of each of Al₂O₃ (hexagonal crystal-base), AlN (hexagonal crystal-base), Si₃N₄ (hexagonal crystal-base), and ZrO₂ (monoclinic crystal-base) has been accomplished by forming them in a strong magnetic field (see Sakka et al., “Fabrication of Oriented β-Alumina from Porous Bodies by Slip Casting in a High Magnetic Field”, Solid State Ion. 172: 341-347 (2004)., Sakka et al., “Textured Development of Feeble Magnetic Ceramics by Colloidal Processing under High Magnetic Field”, J. Ceram. Soc, Jpn. 113: 26-36 (2005)., Sakka et al., “Fabrication and Some Properties of Textured Alumina-related Compounds by Colloidal Processing in High-magnetic Field and Sintering”, J. Eur. Ceram. Soc. 28: 935-942 (2008)., Suzuki et al., “Effect of Sintering Additive on Crystallographic Orientation in AlN Prepared by Slip Casting in a Strong Magnetic Field”, J. Eur. Cearm. Soc. 29: 2627-2633 (2009)).

### SUMMARY OF THE INVENTION

Since a ratio of c and a crystal axes in a unit cell in the MAX phase is large, it is expected that orientation of grains of the MAX phase is controlled in a strong magnetic field. To this end, two main factors need to be addressed. The first one is to prepare a slurry having excellent fluidity, in which each of grains are dispersed, namely preparing a suspension, and the other is to use a strong magnetic field. It is further expected that an extremely hard and strong MAX phase material is obtained by the aforementioned process.

The present invention aims to provide an orientated Max phase ceramic, which is an extremely hard and strong oriented material formed of a MAX phase compound with maintaining desirable characteristics of the MAX phase compound, and to provide a production method thereof.

The present invention is directed to a ceramic in which an Mₙ₊₁AXₙ phase that is a ternary compound has been orientated, and to a production method thereof. Here, M is an early transition metal, A is an A group element, X is C or N, and n is an integer of 1 to 3.

According to another aspect of the present invention, a method for producing an oriented ceramic contains an Mₙ₊₁AXₙ phase that is a ternary compound, the method comprising:

(a) a suspension forming step, containing mixing powder of the Mₙ₊₁AXₙ phase that is the ternary compound, a dispersion medium, and a dispersing agent to form a suspension;

(b) a strong magnetic field applying step, containing applying a strong magnetic field to the suspension with performing solidification forming to thereby obtain a compact;

(c) a pressure applying step, containing applying high pressure to the compact to thereby obtain a pressed compact; and

(d) a sintering step, containing sintering the pressed compact in an inert gas atmosphere or under vacuum, to thereby obtain a sintered compact,

wherein M is an early transition metal, A is an A group element, X is C or N, and n is an integer of 1 to 3.

The present invention can provide an orientated Max phase ceramic, which is an extremely hard and strong oriented material formed of a MAX phase compound with maintaining desirable characteristics of the MAX phase compound, and can provide a production method thereof.

The present invention can provide a layered material having bending strength of greater than 1 GPa, and fracture toughness of 20 MPa·m^{1/2}. Owing to its excellent physical properties in addition to typical characteristics of a MAX phase material (e.g., damage resistance, machinability, and oxidation resistance at high temperature), the oriented MAX phase can be an ideal option in various structural or functional uses.

### BRIEF DESCRIPTION OF THE DRAWINGS

FIG. 1A is an X-ray diffraction (XRD) pattern of a non-oriented surface of an Nb₄AlC₃ sample (the spectrum depicted in the bottom of FIG. 1A), an XRD pattern of an oriented side surface (TSS) thereof (the spectrum depicted in the middle of FIG. 1A), and an XRD pattern of (c) an oriented top surface (TTS) thereof (the spectrum depicted at the tope of FIG. 1A).

FIG. 1B is a diagram illustrating the direction of the magnetic field 12T (depicted with a thick arrow leading upwards) in the Nb₄AlC₃ sample, and the direction for applying pressure (depicted with a narrow arrow leading downwards) during shaping.

FIG. 2A is a scanning electron microscopic photograph depicting the TTS plane of the Nb₄AlC₃ ceramic sample according to one embodiment of the present invention among etched surfaces thereof, and grains in the photograph are Nb—Al oxides.

FIG. 2B is a scanning electron microscopic photograph depicting the TTS plane of the Nb₄AlC₃ ceramic sample according to one embodiment of the present invention among etched fracture surfaces thereof.

FIG. 2C is a scanning electron microscopic photograph depicting the TSS plane of the Nb₄AlC₃ ceramic sample according to one embodiment of the present invention among etched surfaces thereof, where the arrow depictes the direction of the magnetic field 12T in the Nb₄AlC₃ ceramic sample.

FIG. 2D is a scanning electron microscopic photograph depicting the TSS plane of the Nb₄AlC₃ ceramic sample according to one embodiment of the present invention among etched fracture surfaces thereof, where the arrow depictes the direction of the magnetic field 12T in the Nb₄AlC₃ ceramic sample.

FIG. 3A is a scanning electron microscopic photograph depicting an isotropic indentation on the oriented surface of the Nb₄AlC₃ ceramic sample according to one embodiment of the present invention.

FIG. 3B is a scanning electron microscopic photograph depicting an anisotropic indentation on the oriented surface of the Nb₄AlC₃ ceramic sample according to one embodiment of the present invention, where the arrow depictes the direction of the magnetic field 12T in the Nb₄AlC₃ ceramic sample and the inserted diagram in FIG. 3B illustrates an enlarged view of one corner of the indentation.

FIG. 4A is an XRD spectrum of the Ti₃SiC₂ sample according to another example of the present invention with TTS (the spectrum depicted at the top of FIG. 4A) and an XRD spectrum thereof with TSS (the spectrum depicted at the bottom of FIG. 4A), where the Ti₃SiC₂ sample is obtained by orientating in the rotating magnetic field, and sintering at 1,100° C. under pressure of 120 MPa.

FIG. 4B is a diagram illustrating the direction of the magnetic field 12T (depicted with a thick arrow leading upwards) in the Ti₃SiC₂ sample, and the direction for applying pressure (depicted with a narrow arrow leading downwards) during shaping.

FIG. 5A is a SEM picture of the etched TTS plane of the Ti₃SiC₂ sample according to another example of the present invention, where the sample is obtained by orientating in a rotating magnetic field, and sintering at 1,000° C. under pressure of 500 MPa.

FIG. 5B is a SEM picture of the etched TSS plane of the Ti₃SiC₂ sample according to another example of the present invention, where the sample is obtained by orientating in a rotating magnetic field, and sintering at 1,000° C. under pressure of 500 MPa, in which the arrow depictes the direction of the C-axis in the Ti₃SiC₂ sample.

FIG. 6A is a SEM picture of an indentation formed in the polished TTS surface of the Ti₃SiC₂ sample according to another example of the present invention with application of load of 9.8 N, where the sample is obtained by orientating in a rotating magnetic field, and sintering at 1,000° C. under pressure of 500 MPa.

FIG. 6B is a SEM picture of an indentation formed in the polished TSS surface of the Ti₃SiC₂ sample according to another example of the present invention with application of load of 9.8 N, where the sample is obtained by orientating in a rotating magnetic field, and sintering at 1,000° C. under pressure of 500 MPa, in which the arrow depictes the direction of the C-axis in the Ti₃SiC₂ sample.

### DETAILED DESCRIPTION OF THE INVENTION

The present invention is directed to orientation of ceramic of a MAX phase, which is a ternary compound. The ternary compound ceramic is represented by a chemical formula of Mₙ₊₁AXₙ, where M is an early transition metal, A is an A group element, X is C or N, and n=1 to 3. A dispersion medium and a dispersing agent are each appropriately selected. The produced oriented ceramics can be used as structural parts. An amount of the MAX phase in the sample is about 100% by weight relative to the total oriented sample. As for the target for orientation, more than fifty M₂AX phases, five M₃AX₂ phases (Ti₃SiC₂, Ti₃AlC₂, Ti₃GeC₂, Ti₃SnC₂, and Ta₃AlC₂), and seven M₄AX₃ phases (Ta₄AlC₃, Ti₄AlN₃, Ti₄SiC₃, Ti₄GeC₃, Nb₄AlC₃, V₄AlC₃, and Ti₄GaC₃) can be used. In addition to the foregoing MAX phases, several new MAX phases, such as (Ti,Nb)₂AlC, Ti₃Si(Al)C₂, Ti₃Si(Ge)C₂, (V,Cr)₃AlC₂, (V,Cr)₄AlC₃, and (V,Cr)₂GeC, may be selected as the target for orientation by utilizing a solid solution method. Among them, Nb₄AlC₃ and Ti₃SiC₂ are preferable as the MAX phase.

A suspension is produced by mixing the dispersion medium, ceramic powder the ternary compound, and the dispersing agent. As for the ternary compound, Nb₄AlC₃ and Ti₃SiC₂ are preferable. A volume ratio of the ceramic powder in the dispersion medium is preferably 10% to 60% relative to a total volume of the suspension. An amount of the dispersing agent added is preferably 0.1% by weight to 10% by weight, more preferably 1% by weight to 3% by weight, relative to the ceramic powder.

The suspension is poured into a mold formed of gypsum or porous alumina in a glass tube. A final size of the sample depends on an amount of the suspension charged. Specifically, the larger the amount of the suspension used is the larger sample finally obtained. Of course, the mold is not limited to the glass tube. Next, the suspension is placed in a strong magnetic field. Strength of the magnetic field is appropriately selected depending on the intended purpose without any limitation, but it is preferably 1 T to 12 T. The suspension is then dried in air for 10 minutes to 24 hours. This target material for sintering is taken out, and is subjected to cold isostatic pressing to thereby obtain a compact. The applied pressure is preferably 50 MPa to 400 MPa. The resultant is sintered in a furnace, for example, under desirable conditions, such as at the temperature ranging from 1,000° C. to 1,700° C. for 5 minutes to 4 hours, to thereby obtain a dense sample. The heating rate is preferably 1° C./min. to 400° C./min. The pressure applied during the sintering is preferably in a range of 0 MPa to 700 MPa, and the sintering atmosphere is an inert gas atmosphere, or under vacuum.

In order to explain the present invention, MAX phases of Nb₄AlC₃ and Ti₃SiC₂ are used in the following examples. However, it should be understood that the spirit of the present invention is not limited to these specific two ceramics, and is applied to all MAX phases.

The embodiments of the present invention includes, for examples, as follows.

The present invention is directed to a ceramic in which an Mₙ₊₁AXₙ phase that is a ternary compound has been orientated, and to a production method thereof. Here, M is an early transition metal, A is an A group element, X is C or N, and n is an integer of 1 to 3. A dispersion medium may be water, ethanol, or acetone, but it is not limited to the foregoing media. A dispersing agent can be polyethyleneimine (PEI), or a polyacrylic acid material, such as ammonium polyacrylate, but it is not limited to the foregoing materials. The present invention contains the following steps in order to impart orientation to a ceramic material.

Note that, in the present specification, the early transition metal indicates all transition metals belong to A group in a periodic table, such as Ti, V, Cr, Nb, and Ta.

(a) Powder of the MAX phase, the dispersion medium, and the dispersing agent are mixed to form suspension. The rheological behavior of the suspension can be optimized by changing a volume ratio of the powder, and a weight ratio of the dispersing agent, in order to attain preferable characteristics of the oriented ceramic, and moreover, it can be evaluated by measuring viscosity of the suspension.
(b) The suspension is poured into a mold formed of gypsum or porous alumina.
(c) The mold in which the suspension has been poured is placed in a strong magnetic field, and is left to stand for 10 minutes to 24 hours, to thereby perform slip casting.
(d) The compact of the MAX phase is taken out, and the compact is subjected to cold isostatic pressing at pressure of 50 MPa to 400 MPa.
(e) The pressure formed sample is sintered for 5 minutes to 4 hours in a furnace at temperature of 1,000° C. to 1,700° C. Here, a heating rate is 1° C./min. to 400° C./min. Moreover, pressure applied is 0 MPa to 700 MPa, and sintering atmosphere is an inert gas atmosphere, or vacuumed atmosphere.

According to one aspect of the present invention, provided is an oriented ceramics, which contains an Mₙ₊₁AXₙ phase (M is an early transition metal, A is an A group element, X is C or N, and n is an integer of 1 to 3) that is a ternary compound, has a layered microstructure similar to shell layers of pearl, which is formed by laminating a layer of a nano-order to milli-order in a thickness thereof, and is an oriented bulk material a total thickness of which is in milli-order or larger at smallest.

M may be selected from the group consisting of Ti, V, Cr, Nb, Ta, Zr, Hf, Mo and Sc.

A may be selected from the group consisting of Al, Ge, Sn, Pb, P, S, Ga, As, Cd, In, Ti and Si.

The ternary compound may be Nb₄AlC₃, or Ti₃SiC₂.

The oriented ceramic may be substantially composed of the ternary compound.

According to another aspect of the present invention, a method for producing an oriented ceramic contains an Mₙ₊₁AXₙ phase that is a ternary compound, the method comprising:

(a) a suspension forming step, containing mixing powder of the Mₙ₊₁AXₙ phase that is the ternary compound, a dispersion medium, and a dispersing agent to form a suspension;

(b) a strong magnetic field applying step, containing applying a strong magnetic field to the suspension with performing solidification forming to thereby obtain a compact;

(c) a pressure applying step, containing applying high pressure to the compact to thereby obtain a pressed compact; and

(d) a sintering step, containing sintering the pressed compact in an inert gas atmosphere or under vacuum, to thereby obtain a sintered compact,

wherein M is an early transition metal, A is an A group element, X is C or N, and n is an integer of 1 to 3.

The dispersion medium may be selected from the group consisting of water, ethanol, and acetone.

The dispersing agent may be polyethyleneimine or ammonium polyacrylate.

The (b) strong magnetic field applying step may be performed after pouring the suspension into a mold.

The mold may be a glass tube.

The (b) strong magnetic field applying step may be performed for 10 minutes to 24 hours.

Strength of the strong magnetic field may be in a range of 1T to 12T.

The strong pressure may be in a range of 50 MPa to 400 MPa.

The (c) pressure applying step may be performed by cold isostatic pressing.

A heating rate in the (d) sintering step may be in a range of 1° C./min. to 400° C./min.

Sintering temperature in the (d) sintering step may be in a range of 1,000° C. to 1,700° C.

The (d) sintering step may be performed for 5 minutes to 4 hours.

The (d) sintering step may be performed under pressure of 0 MPa to 700 MPa.

The (d) sintering step may be performed by pulse electric current sintering.

M may be selected from the group consisting of Ti, V, Cr, Nb, Ta, Zr, Hf, Mo, and Sc.

A may be selected from the group consisting of Al, Ge, Sn, Pb, P, S, Ga, As, Cd, In, Tl, and Si.

The ternary compound may be Nb₄AlC₃ or Ti₃SiC₂.

A ratio of the powder to the suspension may be 10% by volume to 60% by volume.

A ratio of the dispersing agent to the powder may be 0.1% by weight to 10% by weight.

The ratio of the dispersing agent to the powder may be preferably 1% by weight to 3% by weight.

### EXAMPLES

### Experiment 1

A cylindrical sample having a dense laminate structure of layered ceramic grains was produced by dispersing, in 10 mL of water, 17.6 g of Nb₄AlC₃ ceramic powder, and 2% by weight of a polyethyleneimine dispersing agent relative to the weight of the powder, orientating the ternary compound Nb₄AlC₃ in a strong magnetic field of 12 T, and sintering. Moreover, the details thereof are as follows.

As for the Nb₄AlC₃ ceramic powder, used was one obtained by sintering powder of Nb, Al and C at an appropriate equivalent molar ratio to the chemical equivalent by spark plasma sintering, followed by powderizing. The average grain size of the Nb₄AlC₃ was 0.91 μm, and a surface area of the Nb₄AlC₃ ceramic powder was 10.18 m²/g.

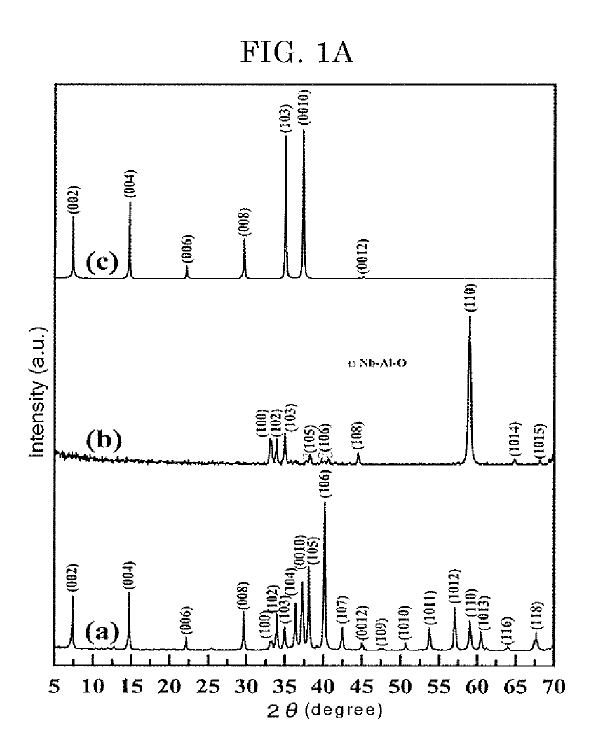

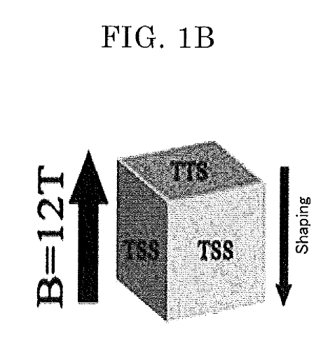

The suspension obtained by the aforementioned dispersing process was poured into a mold formed of gypsum or porous alumina. Next, the mold with the suspension therein was placed in a strong magnetic field. After drying the suspension for 12 hours, a resulting compact was taken out, and subjected to cold isostatic pressing for 3 minutes under pressure of 350 MPa (FIG. 1B). The pressed compact was sintered in a spark plasma sintering furnace for 10 minutes at 1,450° C. under vacuum (10⁻² Pa). The heating rate was 50° C./min. The applied pressure was 30 MPa.

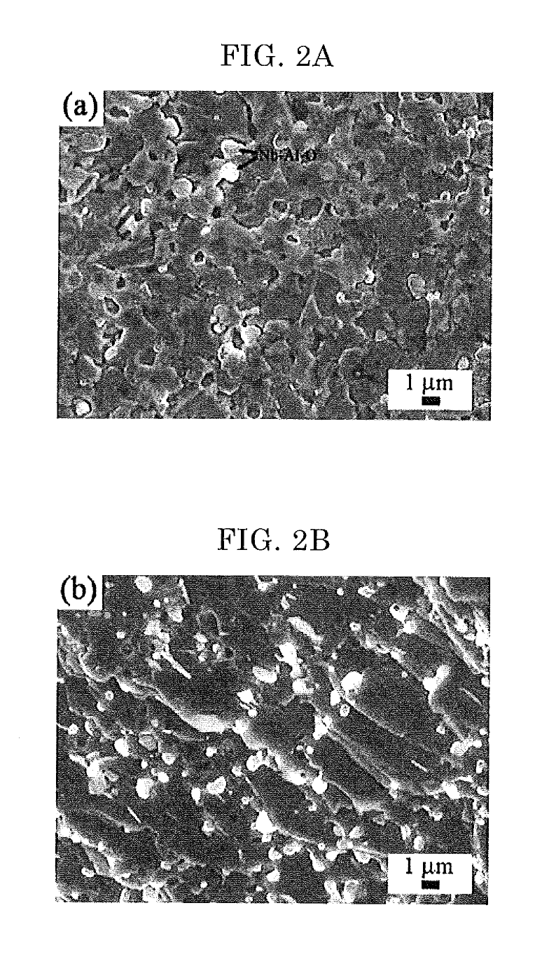

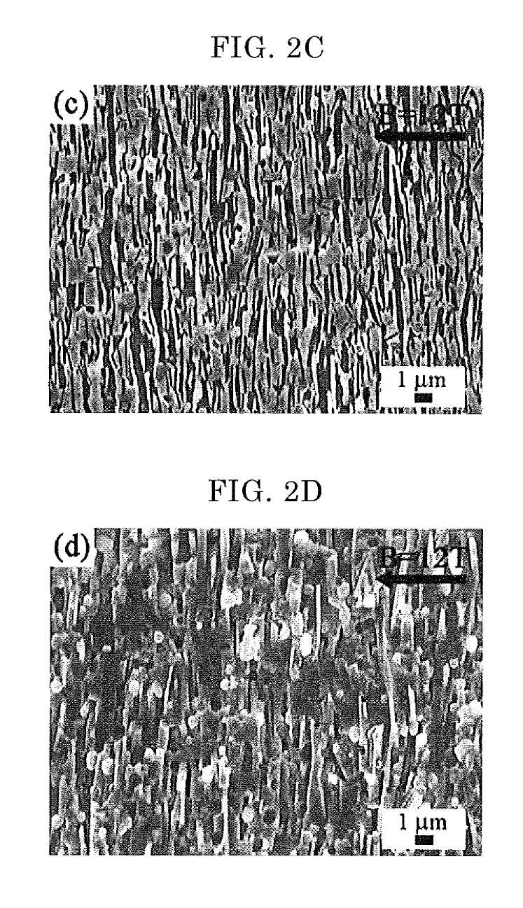

It was understood from the X-ray diffraction analysis and observation under a scanning electron microscope that the oriented Nb₄AlC₃ ceramic as produced had a layered microstructure as depicted in FIG. 1A, and FIGS. 2A to 2D. The preferential orientation direction of the Nb₄AlC₃ grain parallel to the direction of the magnetic field was along the c axis.

On the oriented side surface (textured side surface, TSS), a main diffraction peak was belong to the (110) plane and (10L) plane (the spectrum depicted in the middle of FIG. 1A). On the oriented top surface (textured top surface, TTS), a main diffraction peak was belong to the (10L) plane and (103) plane (the spectrum depicted at the top of FIG. 1A).

Accordingly, it was concluded by comparing between the etched top surface (FIG. 2A) and the etched side surface (FIG. 2C)) that the Nb₄AlC₃ grain tends to grow along the directions of crystal a-axis and c-axis during sintering, and the Nb₄AlC₃ sample had a layered fine gran structure formed of tabular grains each connected with one another.

On the fracture surface, it was clearly observed that the Nb₄AlC₃ grains indicated cracks within and between layered grains (FIGS. 2B and 2D). On the facture top surface, the cracked grains appeared as a terrace shape and indicated a fracture process from the layer to the layer (FIG. 2B). On the oriented side surface, the fractured layered microstructure was clearly identified (FIG. 2D).

Accordingly, in accordance with the orientation technique, the layered MAX phase could be built up to from nano-scale to milli-scale, namely to a layered bulk ceramic.

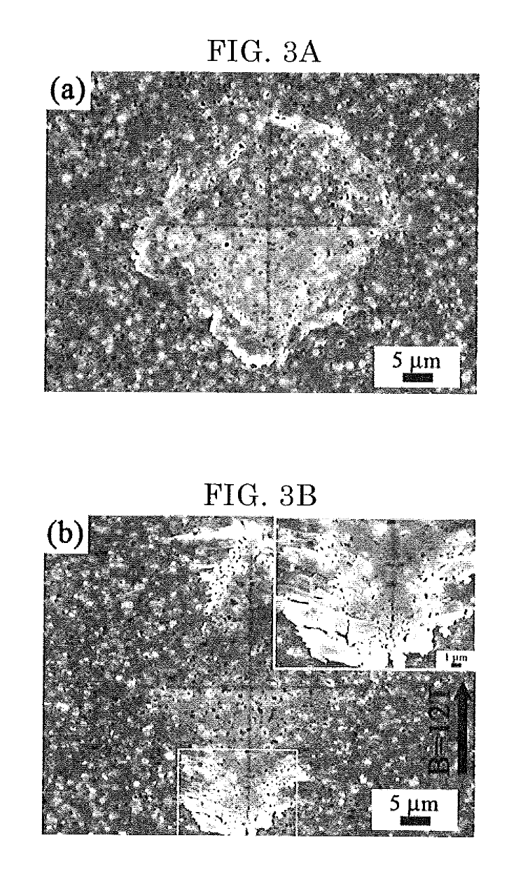

As depicted in FIGS. 3A and 3B, it was found that the Vickers indentation response exhibited isotropy on the oriented top surface, and exhibited anisotropy on the oriented side surface.

Specifically, the indentation on the top surface clearly was appeared as the isotropic square shape, and the diagonal lines of the indentation had length of 39.9 μm±0.7 μm and 40.1 μm±0.6 μm, respectively (FIG. 3A). On the other hand, the indentation on the side surface was appeared as a diamond shape, and the diagonal lines of the indentation had length of 36.9 μm±0.3 μm and 51.1 μm±2.2 μm, respectively, indicating anisotropic plastic deformation and elastic recovery (FIG. 3B).

In FIG. 3A, the grains around the indentation were symmetrically pushed out by shearing deformation.

In FIG. 3B, the grains were pushed out along the vertical direction with respect to the basal plane of the Nb₄AlC₃ grain, and cracked at a position adjacent to an apex of the pressure mark (see the inserted diagram). Moreover, shear slip was observed between a plurality of the Nb₄AlC₃ grains. However, a clear damage was found along another direction parallel to the basal plane of the Nb₄AlC₃ grain.

The Vickers hardness tested on the oriented top surface (11.39 GPa±0.26 GPa) was higher than the value measured on the oriented side surface (9.40 GPa±0.47 GPa) (for the measuring method, see Barsoum et al., “The MN+1AXN Phases: a New Class of Solids; Thermodynamically Stable Nanolaminates”, Prog. Solid State Chem. 28: 201-281 (2000)). The fact that these values were higher than the conventional values (3.7 GPa, see Hu et al., “In Situ Reaction Synthesis, Electrical and Thermal, and Mechanical Properties of Nb₄AlC₃”, J. Am. Ceram. Soc. 91: 2258-2263 (2008)) was owing to that oxides were present (about 15% by volume, calculated by converting the total area ratio in the SEM picture into a volume ratio) in the Nb₄AlC₃ matrix (FIG. 1A). This oxygen was introduced during the production of powder of Nb₄AlC₃ ceramic to be added to a suspension, and the oxides were formed during spark plasma sintering performed at the time when the powder was produced.

Further, bending strength and fracture toughness thereof were tested at room temperature. Here, the bending strength test was performed in accordance with the three-point bending test (sample size: 1.5 mm×2 mm×18 mm), and, the fracture toughness test was performed in according to the SENB test (sample size: 2 mm×4 mm×18 mm).

When the direction of the load applied was a vertical direction with respect to the basal plane of the Nb₄AlC₃ sample, bending strength was a high value, which was 1,185 MPa. When the direction of the load applied was a parallel direction with respect to the base plane of the Nb₄AlC₃ matrix, the measurement value of the bending strength was 1,214 MPa.

When the direction of the load applied was a vertical direction with respect to the basal plane of the Nb₄AlC₃ sample, moreover, fracture toughness was a high value, which was 20 MPa·m^{1/2}. When the direction of the load applied was a parallel direction with respect to the base plane of the Nb₄AlC₃ matrix, the measurement value of the fracture toughness was 11 MPa·m^{1/2}.

Comparing to the previously reported values (see Hu et al., “In Situ Reaction Synthesis, Electrical and Thermal, and Mechanical Properties of Nb₄AlC₃”, J. Am. Ceram. Soc. 91: 2258-2263 (2008)), these values were the highest values of bending strength for ceramics. There is no doubt that this ceramic has remarkable reliability in application.

Accordingly, the present invention has led to significantly remarkable mechanical properties of the oriented MAX phase by the design of the aforementioned microstructure.

### Experiment 2

After slip casting in a strong magnetic field of 12 T, Ti₃SiC₂, which is an oriented transition metal ternary compound, was produced successfully by spark plasma sintering.

As a parameter of a suspension optimized for slip casting, it was determined that 20% by volume of Ti₃SiC₂ powder relative to the suspension, and 1.5% by weight of polyethyleneimine (PEI) serving as a dispersing agent for the powder, relative to the powder were added into ion-exchanged water. This powder was obtained from a commercial route (manufactured by 3-one-2 Corp), and contained about 9.78% by weight of TiC. The average grain size of the Ti₃SiC₂ was about 0.36 μm. The resulting suspension was poured into a mold formed of gypsum or porous alumina.

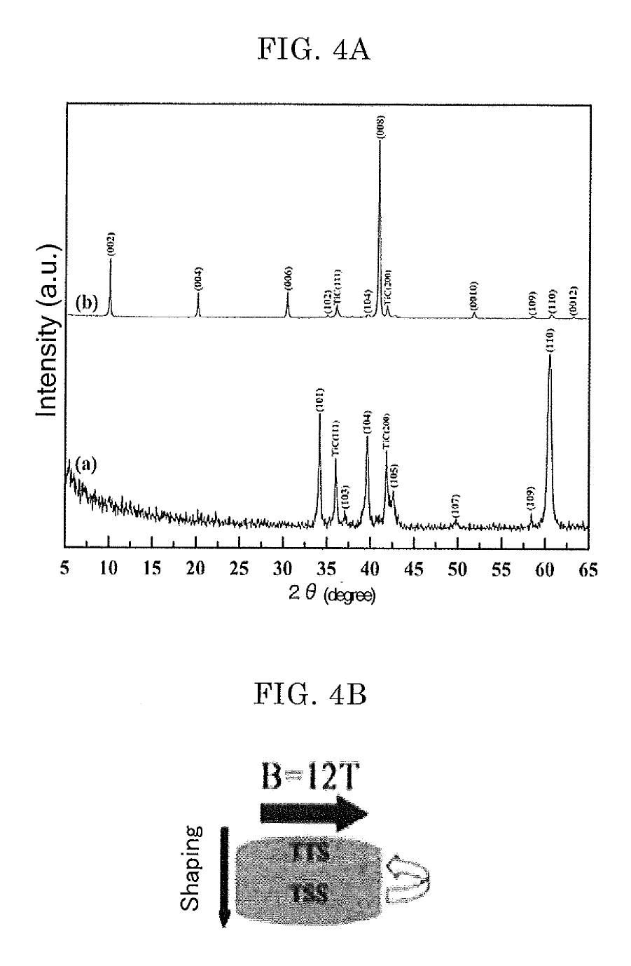

In this operation, used were a steady magnetic field, which was vertical to the horizontal plane, and a rotating magnetic field, which was parallel to the horizontal plane. The rotating speed was set to 20 rpm. It was determined that the rotating magnetic field was more suitable for orientating the Ti₃SiC₂. After drying for 15 hours, this target for sintering was taken out, and subjected to cold isostatic pressing for 10 minutes at pressure of 392 MPa (FIG. 4B). When the resulting sample was sintered at 1,100° C. under pressure of 120 MPa, the relative density reached 88.2%. When the sample was compressed with pressure of 500 MPa, the temperature of 1,000° C. was enough to yield a sufficiently dense sample having the relative density of 98.6%. The heating speed was 50° C./rain.

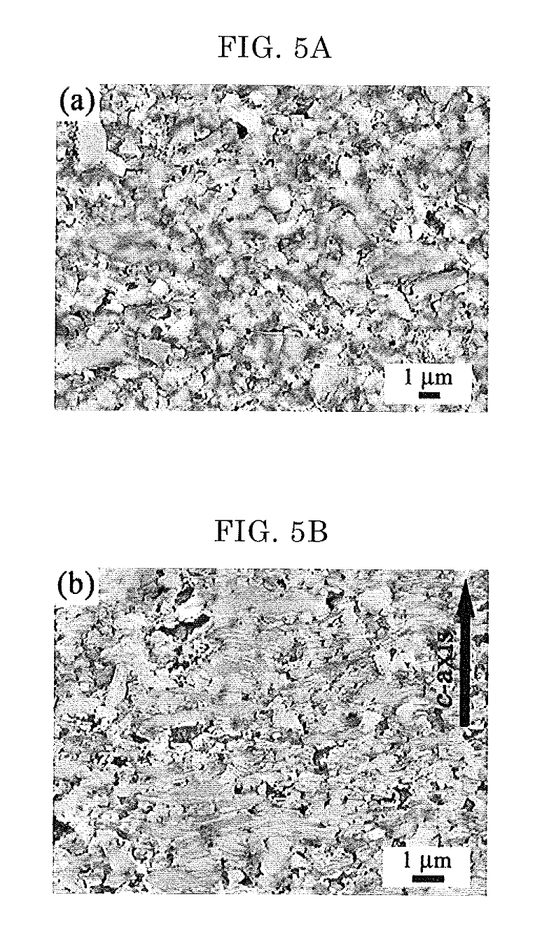

It was confirmed from the analysis of XRD and SEM that the preferential direction vertical to the magnetic direction of the Ti₃SiC₂ grain was along the c-axis of the crystal axis, as depicted in FIG. 4A, and FIGS. 5A and 5B.

Specifically, two (101) and (110) planes had clearly the strongest diffraction peaks on the oriented side surface (the spectrum depicted at the top of FIG. 4A). Interestingly, it was found that only the (00L) plane positioned parallel to the oriented top surface, exclusive of the TiC diffraction peak, on the oriented top surface (the spectrum depicted at the bottom of FIG. 4A). On the oriented top surface, small thin tubular characteristics of the Ti₃SiC₂ grains could not be seen (FIG. 5A), which was different from the etched Ti₃SiC₂ sample having random grain orientation. On the oriented side surface, the Ti₃SiC₂ grains regularly aligned in the direction vertical to the c-axis could be clearly seen in the basal plane (FIG. 5B).

It was also found here that the (00L) basal plane of the oriented Ti₃SiC₂ sample was parallel to the oriented top surface, and a layered microstructure of nano-scale to milli-scale was formed.

The values of the Vickers hardness tested on the oriented top surface and oriented side surface were 8.70 GPa±0.71 GPa, and 7.31 GPa±0.28 GPa, respectively (for a measuring method, see Barsoum et al., “The MN+1AXN Phases: a New Class of Solids; Thermodynamically Stable Nanolaminates”, Prog. Solid State Chem. 28: 201-281 (2000)). The higher hardness than the conventional value (about 4 GPa, see Barsoum et al., “The MN+1AXN Phases: a New Class of Solids; Thermodynamically Stable Nanolaminates”, Prog. Solid State Chem. 28: 201-281 (2000)) was measured probably because TiC was present in the matrix, and the grain size was small.

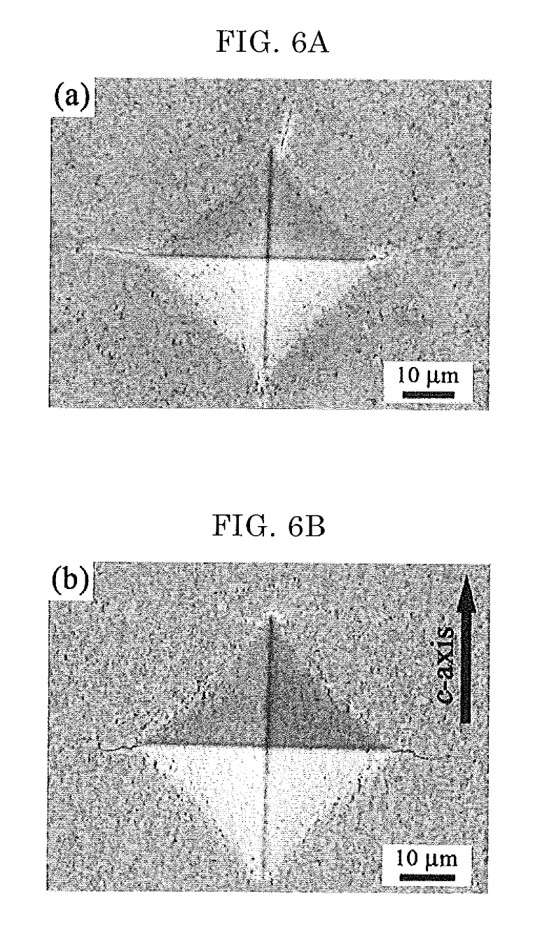

In any case, an isotopic mechanical response of the oriented Ti₃SiC₂ ceramic was verified as depicted in FIGS. 6A and 6B. Cracks were appeared around the angled portions of the pressure mark formed in the oriented top surface (FIG. 6A), but it is probably because the TiC content was large (about 9.78% by weight). However, cracks were run along only along the direction of the basal plane on the oriented side surface (FIG. 6B). It was assumed that this phenomenon occurred because the TiC content was large, and an interface of the grain was weak and the bond of the basal plane was weak.

There was no crack present in the body part along the c-axis (FIG. 6B). It is assumed that the multiplexenergy dispersion occurs due to push-out phenomena. The previous research (see Barsoum et al., “The MN+1AXN Phases: a New Class of Solids; Thermodynamically Stable Nanolaminates”, Prog. Solid State Chem. 28: 201-281 (2000)) has confirmed that pushing out of Ti₃SiC₂ grains relates to delamination, interlaminar fracture, and fracture within and between grains, which can avoid stress concentration by absorbing mechanical energy. As a final reason, it is because many weak interfaces are not present along the c-axis due to the typical crystal structure of Ti₃SiC₂.

It should be mentioned here that various compositions, preparation methods for a suspension, molding method, and sintering methods be used or performed to attain the oriented MAX phase. Such various process factors are within the spirit and scope of the present invention, and do not adversely affect the effects of the present invention. Therefore, these process factors are incorporated within the technical concept of the present invention.

The bending strength and fracture toughness are dramatically enhanced due to the layered microstructure of the MAX phase, and therefore, the oriented phase can be applied to wider fields compared to a ternary compound without orientation. The oriented MAX phase has, in addition to excellent mechanical characteristics, typical characteristics of MAX, such as oxidization resistance, self-lubricating properties, low friction coefficient, and excellent electric conductivity.

Because of the aforementioned physical properties, the oriented MAX phase is particularly suitable for the following applications.

(1) Use as structural parts of chemical or petrochemical plants, because the oriented MAX phase is low cost as a raw material, easily machined, used at high temperature and is resistant to corrosion.
(2) Use as high-temperature turbine parts, because the oriented MAX phase is acid resistant and creep resistant.
(3) Use as a structural material, because of an unparalleled combination of high bending strength and high fracture toughness, which cannot seen with other materials.
(4) Use as a wear resistant electric conductive material, because of excellent electric conductivity, self-lubricating properties, and low friction coefficient.

What is claimed is:

1. An oriented ceramic, comprising:
an Mₙ₊₁AXₙ phase, where the Mₙ₊₁AXₙ phase is a ternary compound, and M is an early transition metal, A is an A group element, X is C or N, and n is an integer of 1 to 3,
wherein the oriented ceramic has a layered microstructure similar to shell layers of pearl, which is formed by laminating a layer of a nano-order to milli-order in a thickness thereof, and the oriented ceramic is an oriented bulk material a total thickness of which is in milli-order or larger at smallest.

2. The oriented ceramic according to claim 1, wherein M is selected from the group consisting of Ti, V, Cr, Nb, Ta, Zr, Hf, Mo, and Sc.

3. The oriented ceramic according to claim 1, wherein A is selected from the group consisting of Al, Ge, Sn, Pb, P, S, Ga, As, Cd, In, Tl, and Si.

4. The oriented ceramic according to claim 1, wherein the ternary compound is Nb₄AlC₃ or Ti₃SiC₂.

5. A method for producing an oriented ceramic containing an Mₙ₊₁AXₙ phase that is a ternary compound, the method comprising:
(a) a suspension forming step, containing mixing powder of the Mₙ₊₁AXₙ phase that is the ternary compound, a dispersion medium, and a dispersing agent to form a suspension;
(b) a strong magnetic field applying step, containing applying a strong magnetic field to the suspension with performing solidification forming to thereby obtain a compact;
(c) a pressure applying step, containing applying high pressure to the compact to thereby obtain a pressed compact; and
(d) a sintering step, containing sintering the pressed compact in an inert gas atmosphere or under vacuum, to thereby obtain a sintered compact,
wherein M is an early transition metal, A is an A group element, X is C or N, and n is an integer of 1 to 3.

6. The method for producing an oriented ceramic according to claim 5, wherein the dispersion medium is selected from the group consisting of water, ethanol, and acetone.

7. The method for producing an oriented ceramic according to claim 5, wherein the dispersing agent is polyethyleneimine or ammonium polyacrylate.

8. The method for producing an oriented ceramic according to claim 5, wherein (b) the strong magnetic field applying step is performed after pouring the suspension into a porous mold.

9. The method for producing an oriented ceramic according to claim 5, wherein (b) the strong magnetic field applying step is performed for 10 minutes to 24 hours.

10. The method for producing an oriented ceramic according to claim 5, wherein strength of the strong magnetic field is in a range of 1 T to 12 T.

11. The method for producing an oriented ceramic according to claim 5, wherein the pressure is in a range of 50 MPa to 400 MPa.

12. The method for producing an oriented ceramic according to claim 5, wherein (c) the pressure applying step is performed by cold isostatic pressing.

13. The method for producing an oriented ceramic according to claim 5, wherein a heating rate in (d) the sintering step is in a range of 1° C./min. to 400° C./min.

14. The method for producing an oriented ceramic according to claim 5, wherein a sintering temperature in (d) the sintering step is in a range of 1,000° C. to 1,700° C.

15. The method for producing an oriented ceramic according to claim 5, wherein (d) the sintering step is performed for 5 minutes to 4 hours.

16. The method for producing an oriented ceramic according to claim 5, wherein the (d) the sintering step is performed under pressure of 0 MPa to 700 MPa.

17. The method for producing an oriented ceramic according to claim 5, wherein the (d) the sintering step is performed by pulse electric current sintering.

18. The method for producing an oriented ceramic according to claim 5, wherein M is selected from the group consisting of Ti, V, Cr, Nb, Ta, Zr, Hf, Mo, and Sc.

19. The method for producing an oriented ceramic according to claim 5, wherein A is selected from the group consisting of Al, Ge, Sn, Pb, P, S, Ga, As, Cd, In, Tl, and Si.

20. The method for producing an oriented ceramic according to claim 19, wherein the ternary compound is Nb₄AlC₃ or Ti₃SiC₂.

21. The method for producing an oriented ceramic according to claim 5, wherein a ratio of the powder to the suspension is 10% by volume to 60% by volume.

22. The method for producing an oriented ceramic according to claim 5, wherein a ratio of the dispersing agent to the powder is 0.1% by weight to 10% by weight.
